(19) United States
(12) Patent Application Publication
(10) Pub. No.: US 2005/0095434 A1
(43) Pub. Date: May 5, 2005

(54) Resin composition, prepreg and laminate using the composition

(75) Inventors: Kousuke Hirota, Sodegaura-shi (JP); Koutarou Asahina, Sodegaura-shi (JP); Kenji Shima, Sodegaura-shi (JP); Hitoshi Sakuraba, Sodegaura-shi (JP); Takashi Iiyama, Sodegaura-shi (JP)

Correspondence Address: BURNS DOANE SWECKER & MATHIS L L P, POST OFFICE BOX 1404, ALEXANDRIA, VA, 22313-1404, US

(73) Assignee: Mitsui Chemicals, Inc., Tokyo (JP)

(21) Appl. No.: 10/978,403

(22) Filed: Nov. 2, 2004

(30) Foreign Application Priority Data
Nov. 5, 2003 (JP) 2003-375126

(51) Int. Cl. B32B 27/38; B32B 27/04; C08L 63/00

(52) U.S. Cl. 428/414; 428/413; 525/523; 528/117

(57) ABSTRACT

The present invention is to provide a laminate which is halogen-free, has sufficient flame retardancy even when a thickness is not more than 0.2 mm, and has sufficient humidity resistance and hygroscopic solder heat resistance. A resin composition comprising: (A) a compound having at least two or more maleimide groups; (B) a phenolic resin; and (C) an epoxy resin; wherein at least one of said (B) or (C) has a naphthalene ring; the total weight of the naphthalene ring when calculated using the OH equivalent and epoxy equivalent of (B) and (C) respectively is not less than 20 weight % to the total weight of (A), (B) and (C) components; and the total sum of the content ratio of the (A) component and that of the naphthalene ring is not less than 65 weight % to the total weight of the (A), (B) and (C) components, and a prepreg and laminate obtained from the same.

### TECHNICAL FIELD

The present invention relates to a resin composition used in the field of electronic materials such as electronic and electric parts, printed wiring boards, semiconductor substrates, IC sealing materials and the like, and use thereof. More specifically, the invention particularly relates to a resin composition which is suitable for printed wiring boards and semiconductor substrates requiring high heat resistance without containing a halogen-containing flame retardant or a phosphorous-containing flame retardant, and which is superior in hygroscopic heat resistance and humidity resistance, and a prepreg and a laminate using the same.

### RELATED BACKGROUND ART

In order to secure safety against a fire, flame retardancy has been required in the field of electronic materials. Regarding laminate materials for printed wiring boards and semiconductor substrates, there is a representative standard of UL94 standard specified by Underwirters Laboratories Inc. It has been required for the vertical flame retardant test to preferably pass the terms in V-1 and more preferably those in V-0. Up to now, all resins that have been used in the related fields include halogen-containing compounds such as bromine-containing compounds and the like as a flame retardant as they have passed the terms thereof. These halogen-containing compounds have high flame retardancy, but aromatic bromine compounds, for example, not only generate bromine and hydrogen bromide having corrosion due to thermal decomposition, but also may possibly generate a compound having high toxicity in the presence of oxygen (refer to pages 69 to 79 (1992), “Halogen-type Flame Retardant”, Flame Retardant Technology of Polymers, published by Taiseisha and written by Hitoshi Nishizawa).

For this reason, materials that do not contain halogen compounds, that is, so-called ┌halogen-free┘ materials have been studied and developed (refer to, for example, JP2003-231762A). Among such materials, phosphorous-containing compounds such as red phosphorous and the like have been intensively reviewed as a flame retardant to replace a halogen-containing flame retardant. However, the phosphorous-containing flame retardant might generate a toxic phosphorous compound such as phosphine and the like while burning. In addition, there is a drawback in that, when a representative phosphate ester was used as a phosphorous-containing compound flame retardant, the humidity resistance of the composition was remarkably deteriorated.

On the other hand, metal hydroxides are known as other flame retardants. For example, aluminium hydroxide is known to have the effect of flame retardant by the reaction as described below for releasing crystal water while heating.
2Al(OH)₃→Al₂O₃+3H₂O

However, when a metal hydroxide such as aluminium hydroxide and the like is used singly as a flame retardant, in order to obtain required flame retardant performance, a large amount of the metal hydroxide needs to be added. When a laminate is formed by using an epoxy resin in general and aluminium hydroxide as a flame retardant, the amount added of the aluminium hydroxide necessary for achieving the V-0 level in the UL 94 standard is about 70 weight % to 75 weight %. Even when a resin having a skeleton which makes it difficult to burn is used, the aluminium hydroxide of about 50 weight % is required to be added (refer to pages 159 to 165 (2003), Journal of Japan Institute of Electronics Packaging 5(2), Yukihiro Kiuchi and Masatoshi Iji). When the amount of the aluminium hydroxide is high, performance of a resin composition and a laminate comprising a resin thereof, especially humidity resistance and heat resistance after hygroscopicity (solder heat resistance) are remarkably reduced (refer to JP2001-226465A). Humidity resistance and heat resistance after hygroscopicity have greatly influenced on the reliability during mounting when a laminate was used as a substrate for a semiconductor and the like so that improvement has been required.

Also, when flame retardancy of a laminate was conventionally evaluated, in many cases, a laminate having a thickness of 1.6 mm or the like was used for evaluation. Accompanied with recent electronic equipments to be “light weight”, “thin” and “downsizing”, a thickness of a laminate used for a semiconductor substrate has been required to be 0.5 mm or less, and preferably 0.2 mm or less. As the thickness of a laminate gets thinner and thinner, it is easy to contact with oxygen while burning and easy to burn so that a large amount of a flame retardant is generally needed. For this reason, in order to satisfy flame retardancy for a thin laminate and obtain laminate materials having sufficient humidity resistance and solder heat resistance after hygroscopicity, a resin composition having high flame retardancy has been further required.

The present applicant has proposed a resin composition containing a specific maleimide group as a resin having high flame retardancy (refer to JP2003-119348A and JP2003-147170A). However, in these cases, it was difficult to obtain sufficient flame retardancy that can be born against the strict flame retardancy test which was performed for a thin substrate having a thickness of 0.2 mm or less. Meanwhile, when a specific epoxy resin having a naphthalene ring was used in order to enhance the heat resistance under hygroscopic condition required for substrate materials, sufficient heat resistance could be obtained (refer to JP2003-335925A). However, as heat resistance and flame retardancy are not necessarily the same trend, it was difficult to obtain resin composition having both sufficient heat resistance and flame retardancy.

### DISCLOSURE OF THE INVENTION

An object of the present invention is to provide a resin composition which is halogen-free, has sufficient flame retardancy and sufficient humidity resistance and hygroscopic solder heat resistance when it is used as a substrate having a thickness of 0.5 mm or less, and a laminate.

As a result of an extensive review in order to accomplish the aforementioned object, the present inventor has found when a resin composition comprised a compound having a specific maleimide group, a phenolic resin and an epoxy resin, wherein at least one of the phenolic resin or epoxy resin has a naphthalene ring, the total weight of the naphthalene ring contained in the resin is a specific ratio or more, and the sum of the content ratio of a compound having a maleimide group and that of a naphthalene ring contained in a resin was within a specific range, a resin composition superior in flame retardancy, humidity resistance and heat resistance could be obtained. Thus, the present invention has been completed.

Namely, the present invention relates to:
1) A resin composition comprising: (A) a compound having at least two or more maleimide groups; (B) a phenolic resin; and (C) an epoxy resin; wherein at least one of said (B) or (C) has a naphthalene ring; the total weight of the naphthalene ring when calculated using the OH equivalent and epoxy equivalent of (B) and (C) respectively is not less than 20 weight % to the total weight of the (A), (B) and (C) components; and the total sum of the content ratio of the (A) component and that of the naphthalene ring is not less than 65 weight % to the total weight of the (A), (B) and (C) components; preferably
2) The resin composition as described in 1), wherein the content of the (A) compound having at least two or more maleimide groups is not less than 3.5 weight % to the total weight of the (A), (B) and (C) components as the content of a nitrogen atom contained in a maleimide ring; more preferably
3) The resin composition as described in 1), further comprising a metal hydroxide;
4) A prepreg obtained by impregnating a substrate with the resin composition as described 1);
5) A laminate wherein a sheet or a plurality of sheets laminated of the prepregs as described in 4) are characterized in being heat-cured; and
6) A laminate comprising the resin layer obtained from the resin composition as described in 1) as an insulating layer.

### EFFECT OF THE INVENTION

Because the resin composition of the present invention has high flame retardancy, sufficient flame retardancy can be obtained even when a laminate comprising the resin composition has a thickness of as thin as 0.5 mm or less. Also, as flame retardancy of the resin composition is high, flame retardants that might deteriorate hygroscopic property of a metal hydroxide and the like do not need to be added or such flame retardants can just be added in a small amount as compared to the usual. As a result, a resin composition and a laminate comprising the same have high humidity resistance and hygroscopic heat resistance.

### BEST MODE FOR CARRYING OUT THE INVENTION

The present invention will be described in more detail below.

The resin composition of the present invention comprises (A) a compound having at least two or more maleimide groups, (B) a phenolic resin and (C) an epoxy resin.

First, each component of the resin composition used in the present invention is described below.

(A) Compound having at least two or more maleimide groups

The compound having at least two or more maleimide groups to be used in the present invention is not particularly restricted as far as a compound contains at least two or more maleimide groups, but a compound represented by the following formula (1) is preferred. 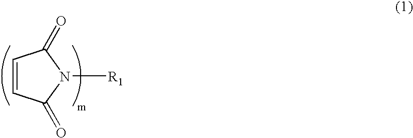
wherein R₁ represents an m-valent organic group and m is an integer of 2 or more and preferably 2 to 10. As an organic group expressed by R₁, preferable examples include those that are selected from a group of the following formula (2-1) to (2-3): 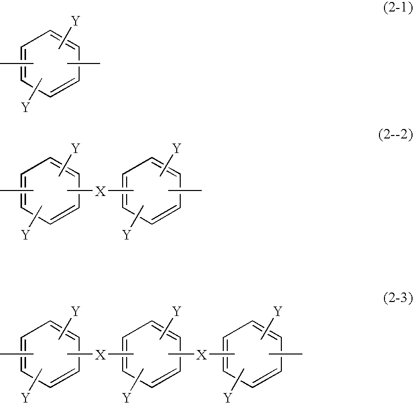
wherein X may be the same or different from each other and represents —CH₂—, —C(CH₃)₂—, —C(C₂H₅)₂—, —CO—, —O—, — (single bond), —S— or —SO₂—. Y may be the same or different from each other and represents —CH₃, —CH₂CH₃ or a hydrogen atom.

As a compound having at least two or more maleimide groups to be used in the present invention, there can be specifically mentioned, for example, N,N′-(1,3-phenylene)bismaleimide, N,N′-[1,3-(2-methylphenylene)]bismaleimide, N,N′-(1,4-phenylene)bismaleimide, bis(4-maleimidophenyl)methane, bis(3-methyl-4-maleimidophenyl)methane, bis(4-maleimidophenyl)ether, bis(4-maleimidophenyl)sulfone, bis(4-maleimidophenyl)sulfide, bis(4-maleimidophenyl)ketone, 1,4-bis(maleimidomethyl)benzene, 1,3-bis(3-maleimidophenoxy)benzene, bis[4-(4-maleimidophenoxy)phenyl]methane, 1,1-bis[4-(3-maleimidophenoxy)phenyl]ethane, 1,1-bis[4-(4-maleimidophenoxy)phenyl]ethane, 1,2-bis[4-(3-maleimidophenoxy)phenyl]ethane, 1,2-bis[4-(4-maleimidophenoxy)phenyl]ethane and the like.

Furthermore, as a compound having at least two or more maleimide groups to be used in the present invention, there can be mentioned a compound having maleimide groups represented by the following formula (3), represented by the following formula (4) or the like: 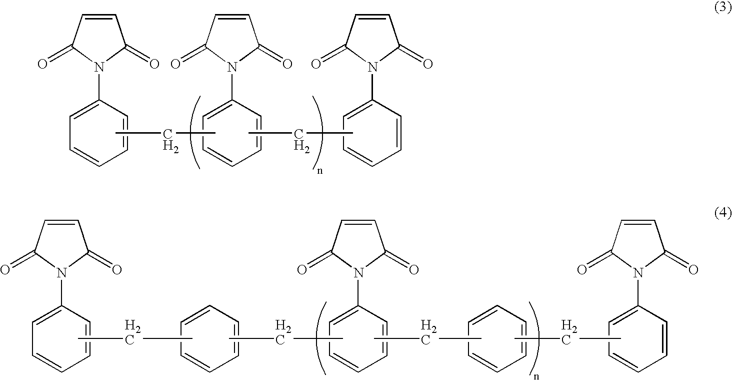
wherein n is 0 to 10 in average. The (A) compounds having these maleimide groups can be used singly or in combination of 2 or more kinds.

(B) Phenolic Resin

The phenolic resin used in the present invention is not particularly restricted as far as it contains a compound having a phenolic hydroxyl group. The phenolic resin preferably contains a compound having a phenolic hydroxyl group having at least one naphthalene ring. As far as this condition is satisfied, a phenolic resin is not particularly restricted. As examples of a compound having a phenolic hydroxyl group having at least one naphthalene ring, there can be mentioned as described below.

Examples include hydroxynaphthalenes and the like such as dihydroxynaphthalene, trihydroxynaphthalene, tetrahydroxynaphthalene and the like; a compound obtained by reacting hydroxynaphthalenes with aldehydes; and a compound obtained by reacting a mixture of hydroxynaphthalenes and phenols with aldehydes. As hydroxynaphthalenes, there can be mentioned, for example, naphthol, dihydroxynaphthalene and the like. As phenols, there can be mentioned, for example, phenol, cresol, resorcinol and the like. Also, as aldehydes, there can be mentioned, for example, formaldehyde, acetaldehyde, benzaldehyde and the like. Specific examples of these compounds include a compound represented by the following formula (5) and the like. 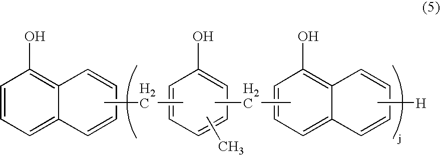
wherein j is 0 to 10 in average.

Incidentally, these compounds can be obtained by the aforementioned method. However, a commercial product such as KAYAHARD NHN manufactured by Nippon Kayaku Co., Ltd. can also be used.

Or there can be mentioned, for example, hydroxynaphthalenes and compounds obtained by reacting a mixture of these hydroxynaphthalenes and phenols with an aralkyl alcohol derivative or aralkyl halide derivative. As aralkyl alcohol derivatives, there can be mentioned, for example, p-xylylene glycol, p-xylylene glycol dimethyl ether and the like. Also, as aralkyl halide derivatives, there can be mentioned, for example, p-xylylene dichloride and the like. Specific examples of these compounds include a compound represented by the following formula (6) and the like. 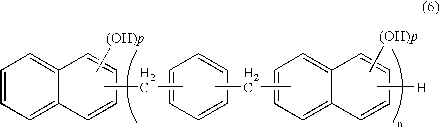
wherein p is 1 or 2, and n is an integer of 1 to 10.

Incidentally, these compounds can be obtained by the aforementioned method. However, a commercial product such as SN180 manufactured by Nippon Steel Chemical Co., Ltd. can also be used. These phenolic resins can be used singly or in combination of 2 or more kinds.

(C) Epoxy Resin

The epoxy resin (C) to be used in the present invention is not particularly restricted as far as it contains an epoxy group.

The epoxy resin to be used in the present invention preferably contains an epoxy compound having at least one naphthalene ring. As an epoxy resin having at least one naphthalene ring, there can be specifically mentioned as described below.

For example, there are a compound obtained by reacting hydroxynaphthalenes such as dihydroxynaphthalenes, trihydroxynaphthalenes and tetrahydroxynaphthalenes with epichlorohydrin, and the like. Incidentally, these compounds can be obtained by the aforementioned method. However, a commercial product such as Epicron HP4032 manufactured by DaiNippon Ink and Chemicals, Inc. can also be used.

There can also be mentioned, for example, compounds obtained by further reacting epichlorohydrin with a product that is obtained by reacting hydroxynaphthalenes such as naphthol, dihydroxynaphthalene and the like with aldehydes such as formaldehyde, acetaldehyde, benzaldehyde and the like; or a product that is obtained by reacting a mixture of the hydroxynaphthalenes and phenols such as phenol, cresol, resorcinol and the like with aldehydes. Specific examples of these compounds include a compound represented by the formula (7) and the like. 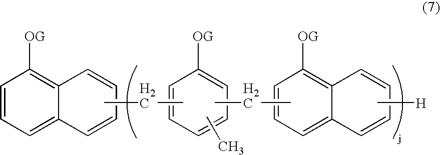
wherein G is a glycidyl group and j is 0 to 10 in average.

Incidentally, these compounds can be obtained by the aforementioned method. However, a commercial product such as NC-7000 manufactured by Nippon Kayaku Co., Ltd. can also be used.

There can also be mentioned, for example, compounds obtained by further reacting epichlorohydrin with a product that is obtained by reacting hydroxynaphthalenes such as naphthol, dihydroxynaphthalene and the like with an aralkyl alcohol derivative or aralkyl halide derivative; or a product that is obtained by reacting a mixture of the hydroxynaphthalenes and phenols such as phenol, cresol, resorcinol and the like with an aralkyl alcohol derivative or aralkyl halide derivative. Specific examples of these compounds include a compound represented by the formula (8) and the like. 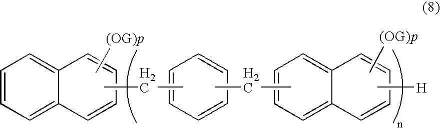
wherein G is a glycidyl group, p is 1 or 2, and n is an integer of 1 to 10.

Incidentally, these compounds can be obtained by the aforementioned method. However, a commercial product such as ESN-175 manufactured by Nippon Steel Chemical Group can also be used. These epoxy compounds can be used singly or in combination of 2 or more kinds.

Also, the resin composition of the present invention preferably contains a liquid epoxy resin as an epoxy resin. A liquid epoxy resin is not particularly restricted. However, desirable examples include an epoxy resin which is liquid at room temperature. Specific examples include an epoxy resin by reacting bisphenol such as bisphenol A, bisphenol F and the like with epichlorohydrin and oligomer thereof and the like. The liquid epoxy resins can be used singly or in combination of 2 or more kinds. As an epoxy resin which is liquid at room temperature has a relatively low molecular weight, the crosslinking density becomes high while curing and it is possible to make a resin composition strong. Also, the resin is liquid at room temperature, which gives fluidity to the resin in the drying process when producing a prepreg and contributes to the smoothness of the surface of the prepreg. Therefore, a drawback on the surface appearance of an orange peel and the like can be prevented.

The content of the liquid epoxy resin is preferably 0.1 to 10 weight % to the resin components (the total weight of the (A), (B) and (C) components) of the resin composition. If the content is in the aforementioned range, the effect of preventing a drawback on the surface appearance is high and flame retardancy of the resin composition is sufficient; therefore such content is preferred.

Resin Composition

The resin composition of the present invention comprises (A) a compound having at least two or more maleimide groups, (B) a phenolic resin and (C) an epoxy resin.

The resin composition of the present invention may contain other resin components (hereinafter referred to as ‘other components’) in addition to the aforementioned (A), (B) and (C) within the range of not damaging the object of the present invention.

The content of the (B) phenolic resin and (C) epoxy resin is that the total weight of the naphthalene ring when calculated using the OH equivalent and epoxy equivalent of (B) and (C) respectively is preferably not less than 20 weight %, and more preferably not less than 25 weight % and not more than 50 weight % to the total weight of the (A), (B) and (C) components.

Incidentally, the weight m_{Nap} (B) of the naphthalene ring of the (B) phenolic resin can be obtained by using the following formula.
m_{Nap}(B)=(weight of (B))÷(OH equivalent of (B))×(1÷(number of OH groups in a naphthalene ring in (B))×128

Also, the weight m_{Nap} (C) of the naphthalene ring of the (C) epoxy resin can be obtained by using the following formula.
m_{Nap}(C)=(weight of (C))÷(epoxy equivalent of (C))×(1÷(number of epoxy groups in a naphthalene ring in (C))×128

The weight ratio M_{Nap}(total) of the naphthalene ring to the total weight of the resin components can be obtained by using the following formula.
M_{Nap}(total)=(m_{Nap}(B)+m_{Nap}(C))÷(total weight of (A)+(B)+(C) components)

When the weight ratio M_{Nap}(total) of the naphthalene ring to the total weight of the resin components is not less than 20 weight %, flame retardancy of the resin composition is high, and humidity resistance is also high. Furthermore, the resin composition can improve heat resistance as a rigid naphthalene ring enhances heat resistance. When the total weight of the naphthalene ring does not satisfy 20 weight %, it is difficult to obtain sufficient flame retardancy. The content ratio of the naphthalene ring in the phenolic resin and epoxy resin having a naphthalene ring is about 40 to 60 weight % in average. Therefore, when the total weight of the naphthalene rings of not more than 50 weight % is preferred from the viewpoint of heat resistance as the content of a maleimide compound in the resin composition is not reduced.

Furthermore, the sum of the content ratio M_{Nap}(total) of the naphthalene ring in the aforementioned resin composition and the content ratio Xₘ of the (A) a compound having at least two or more maleimide groups in the (A), (B) and (C) components is not less than 65 weight % and preferably not less than 70 weight %.

The content ratio of the (A) a compound having at least two or more maleimide groups in the (A), (B) and (C) components can be obtained by the following formula.
Xₘ=(weight of (A))÷(total weight of (A)+(B)+(C)components)

When M_{Nap}(total) is not less than 20 weight %, and the sum of M_{Nap}(total) and Xₘ is not less than 65 weight % and preferably not less than 70 weight %, flame retardancy of the resin composition is high and hygroscopicity is low, and heat resistance under hygroscopic condition is high as well, as compared to the case where the content ratio of the naphthalene ring or that of the compound having a maleimide group is adjusted to 65 weight % or more. On the other hand, M_{Nap}(total) is preferably not more than 85 weight %. M_{Nap} (total) of 85 weight % or less is preferred as brittleness of the resin composition is low and it is difficult to cause crack and the like in case of substrate materials.

The content of the (A) a compound having at least two or more maleimide groups as the content of a nitrogen atom in the (A) a compound having at least two or more maleimide groups is preferably not less than 3.5 weight and not more than 6.5 weight %, and more preferably not less than 4.0 weight % and not more than 6.0 weight % to the total weight of the (A), (B) and (C) components. When the content of the (A) a compound having at least two or more maleimide groups in the resin composition is within the aforementioned range, a substrate, a laminate and the like obtained from the resin composition have sufficient flame retardancy. Incidentally, as the content of the nitrogen atom in the (A) a compound having at least two or more maleimide groups is a maximum of about 14%, the total amount of the phenolic resin (B) and epoxy resin (C) is a maximum of about 75 weight %.

The mixing ratio of the phenolic resin (B) and epoxy resin (C) is not particularly restricted. However, the number of epoxy groups in the epoxy resin (C) to the OH group in the phenolic resin (B) is preferably 0.2 to 5.0 and more preferably 0.5 to 3.0. When the mixing ratio of the phenolic resin (B) and epoxy resin (C) is within the aforementioned range, the resin composition is sufficiently cured so that a laminate is superior in humidity resistance, solder heat resistance and the like.

Other Resin Components

Reactive diluents and the like may be added to the resin composition of the present invention as desired in addition to the aforementioned various components within the range of not damaging flame retardancy.

As a reactive diluent, there can be mentioned, for example, a reactive diluent to be generally used for epoxy resins such as glycidol, allyl glycidyl ether, methyl glycidyl ether, butyl glycidyl ether, phenyl glycidyl ether and the like; and a compound having an allyl group such as diallylphthalate, o,o′-diallyl bisphenol A, bisphenol A diallylether (these are reactive diluents to be generally used for thermosetting imide resin).

The content of these reactive diluents is preferably 0.1 to 10 weight % to the resin component. When the content is less than 0.1 weight %, there is a possibility to have a small effect as a reactive diluent. When the content is not less than 10 weight %, the viscosity of a resin varnish comprising a resin composition is remarkably reduced, so there are cases where the workability gets worse.

Metal Hydroxides

It is preferable for the resin composition of the present invention further comprising metal hydroxides. A metal hydroxide to be used for the resin composition of the present invention is not particularly restricted as far as it is a metallic compound having (OH)ₙ such as aluminium hydroxide, magnesium hydroxide, zinc hydroxystannate and the like. However, aluminum hydroxide (Al(OH)₃), magnesium hydroxide (Mg(OH)₂), zinc hydroxystannate (ZnSn(OH)₆) and the like are preferred. Aluminium hydroxide is more preferred.

Also, it is preferable for these metal hydroxides that the content of Na₂O to be included as impurities is low. The content of Na₂O is preferably not more than 0.3%, more preferably 0.2% or less, and further preferably 0 to 0.1%. When the amount of Na₂O to be included in the metal hydroxide as impurities is high, it is preferable to use metal hydroxides after the amount of Na₂O to be included is reduced down to less than 0.3% according to a method for washing or a method as disclosed in JP96-325011A and the like. If the content of Na₂O of metal hydroxide is within the above range, a laminate which is obtained from the heat resistant resin composition containing the metal hydroxide is particularly superior in solder heat resistance. Also, when the laminate is used as a circuit substrate, it hardly causes deterioration of reliability due to ion migration. The diameter of the metal hydroxide to be used in the present invention is not particularly restricted. However, the average diameter of 0.1 to 10 μm is usually used. The metal hydroxides can be used singly (1 kind) or in combination of 2 or more kinds.

Also, it is preferable to employ a coupling agent in the aforementioned metal hydroxides. Coupling agents such as silane coupling agent, titanate coupling agent, aluminate coupling agent, zirco-aluminate coupling agent and the like can be used. Among them, a silane coupling agent is preferred and especially a silane coupling agent having a reactive functional group is more preferred.

As a silane coupling agent, there can be mentioned, for example, vinyltrimethoxy silane, vinyltrimethoxy silane, N-(2-aminoethyl)-3-aminopropylmethyldimethoxy silane, N-(2-aminoethyl)-3-aminopropyltrimethoxy silane, N-phenyl-γ-aminopropyltrimethoxy silane, 3-aminopropyltriethoxy silane, 3-anilinopropyltrimethoxy silane, 3-glycidoxypropyltrimethoxy silane, 3-glycidoxypropylmethyldimethoxy silane, 2-(3,4-epoxycyclohexyl)ethyltrimethoxy silane, 3-methacryloxypropyltrimethoxy silane, 3-mercaptopropyltrimethoxy silane and the like. One or 2 or more kinds thereof are used in combination. It is preferable that the silane coupling agents may be attached on the surface of metal hydroxide in advance by absorption or a reaction. If a coupling agent is used, the adhesiveness between a metal hydroxide and a resin is increased So that improvement of the mechanical strength and heat resistance of a laminate obtained from the resin composition can be expected.

Metal hydroxides are contained preferably 5 to 100 weight parts and more preferably 5 to 80 weight parts to 100 weight parts of the total weight of the (A), (B) and (C) components. When the content of metal hydroxide is in the above range, the impregnating property to a substrate having proper viscosity of a varnish, which can obtain the effect of flame retardation, is good and the workability is superior. Also, when the content of metal hydroxide exceeds 100 weight parts (exceeding 50 weight % in the resin composition), the resin composition has high water absorption and has a bad influence on solder heat resistance and the like after hygroscopicity.

The resin composition according to the present invention does not substantially contain phosphorous flame retardant and halogen flame retardant, so the content of phosphorous flame retardant and halogen flame retardant is not more than 0.05 in terms of phosphorous or halogen. Incidentally, according to the definition of “halogen-free” defined by the Japan Printed Circuit Association (JPCA), as the content of halogen in a copper laminate is not more than 0.09, the resin composition and the laminate of the present invention are applicable to this.

Curing Accelerator

It is preferable for the resin composition of the present invention to further contain a curing accelerator. As a curing accelerator, there can be mentioned, for example, imidazols groups such as 2-methyimidazol, 2-ethyl4-methylimidazol, 2-heptadecylimidazol, 2-ethyl-4-methylimidazoltetraphenylborate and the like; amines such as triethanolamine, triethylenediamine, N-methylmorpholine and the like; tetraphenylboron salts such as tetraphenylphosphonium tetraphenylborate, triethylammonium tetraphenylboate and the like; 1,8-diaza-biscyclo(5,4,0)undecene-7 and derivatives thereof. The curing accelerators can be used singly or in combination of 2 or more kinds.

The content of a curing accelerator may preferably be compounded such that time required for desired gelation of a varnish or prepreg to be described later can be secured. However, in general, the content is 0.005 to 5 weight parts to 100 weight parts of the total amount of the resin component (total amount of (A), (B) and (C) components).

Inorganic Filler

Inorganic filler can be added to the resin composition of the present invention. Desirable examples of the inorganic filler include silica, alumina, titanium oxide, talc, calcinated talc, kaolin, mica, clay, aluminium nitride, glass and the like. Silica, alumina, titanium oxide, and talc are more preferred. Globule of silica and talc are particularly preferred. Silica, alumina and titanium oxide can contribute to the improvement of the elastic modulus when they are added in a small amount as the hardness is high. When globule of the inorganic filler is used, it is preferable as the viscosity of a resin varnish is not extremely increased and the inorganic filler becomes superior in the workability afterward. When talc is particularly squamous, such talc can contribute to the improvement of the flexural modulus. The content of the inorganic filler is preferably 10 to 150 weight parts to 100 weight parts of the total amount (total amount of (A), (B) and (C) components) of the resin components in general.

Additive

An additive can be added to the resin composition of the present invention according to use. Desirable examples of an additive include additives, which are generally used as an antifoaming agent, a leveling agent and a surface tension modifier. As an additive, there can be specifically mentioned, for example, an antifoaming agent such as a fluoride additive, silicon additive, acrylic additive and the like; and a leveling agent. The content of an additive is preferably 0.0005 to 5 weight parts to 100 weight parts of the total amount (total amount of (A), (B) and (C) components) of the resin component in general.

Method for Manufacturing a Resin Composition

The resin composition of the present invention, for example, comprises (A) a compound having at least two or more maleimide groups, a phenolic resin (B) and an epoxy resin (C) which are heated and mixed at 80° C. to 200° C. for 0.1 to 10 hours for a uniform mixture. When a metal hydroxide and inorganic filler are added, the aforementioned mixture can be ground at room temperature and mixed at a powder state, and the aforementioned metal hydroxide and inorganic filler can be combined in a resin varnish to be described below.

Resin Varnish

The resin varnish of the present invention contains a compound having at least two or more maleimide groups (A), a phenolic resin (B) and an epoxy resin (C) which are dissolved in a solvent.

As a solvent used for the resin varnish, there can be mentioned, for example, ethyleneglycolmonoethylether, propyleneglycolmonomethylether, ethyleneglycolmonobutylether, N,N-dimethylformamide, N,N-dimethylacetoamide, dioxane, acetone, N-methyl-2-pyrrolidone, dimethylsulfoxide, methylethylketone, methylisobutylketone, cyclohexane, 2-heptanone and the like. It is preferable for a solvent to have a relatively low boiling point. Methylethylketone, acetone, dioxane or a mixture having main ingredients thereof can be preferably used.

The resin varnish according to the present invention may contain other resin components in addition to the aforementioned (A), (B) and (C). The content of the a compound having at least two or more maleimide groups (A), a phenolic resin (B) and an epoxy resin (C) in the resin varnish is the same as that of the aforementioned resin composition.

It is preferable for the resin varnish according to the present invention to contain a curing accelerator as shown above and the content is the same as the above. Also, the resin varnish according to the present invention can contain ‘other resin components’ which may be contained in the aforementioned resin composition. The total weight of the aforementioned (A), (B) and (C) in the resin varnish is usually 50 to 80 weight % and preferably 50 to 70 weight %.

The resin varnish can be controlled by heating and mixing a compound having at least two or more maleimide groups (A), a phenolic resin (B), an epoxy resin (C) and other resin components in an organic solvent to make a uniform solution. The temperature during heating and mixing depends on the boiling point of an organic solvent, but it is usually 50° C. to 200° C. The time required for heating and mixing is usually 0.1 to 20 hours. Also, the resin varnish of the present invention can be controlled by mixing the resin composition with the solvent and dissolving the resin composition in the solvent.

Prepreg

In the prepreg of the present invention, the resin composition is impregnated on a substrate. The prepreg of the present invention can be produced by coating or impregnating the resin varnish on a substrate, and then drying for removing the solvent. As a substrate, all known substrates used for conventional prepregs such as glass nonwoven fabric, glass fiber cloth, carbon fiber cloth, organic fiber cloth, paper and the like can be used. The resin varnish is coated or impregnated on the substrate and then a prepreg is produced through a drying process. However, methods for coating, impregnating and drying are not particularly restricted as known methods have been used.

Drying conditions are properly determined depending on the boiling point of a solvent in use. However, such a condition for the amount of the residual solvent in a prepreg of 1 weight % or less is preferred. As a specific example, the residence time is preferably about 5 to 10 minutes at a temperature range of 140° C. to 220° C. However, in a production process for drying a prepreg continuously, the temperature range is not restricted as the optimum temperature range varies depending on the carrying speed.

Laminate

A sheet or a plurality of sheets of the aforementioned prepreg are laminated and heat-cured by the hot press to produce the laminate according to the present invention. The conditions of heat-pressurizing for producing a laminate are not particularly restricted. However, the heating temperature is preferably 100° C. to 300° C. and more preferably 150° C. to 250° C., the pressure is preferably 1.0 to 10 MPa, and the time required for heat-pressurizing is about 10 to 300 minutes.

The laminate according to the present invention also include a both-sided metal clad laminate that metal foils or metal plates are laminated on both sides of the aforementioned laminate and integrated into a single body. The both-sided metal clad laminate can be produced by laminating metal foils or metal plates on one side or both sides of a sheet of the prepreg for hot pressing or laminating metal foils or metal plates on both sides of the outermost layers of a plurality of sheets of the prepregs for hot pressing, and then heat-curing the prepreg for integrating into a single body. A metal foil or a metal plate is not particularly restricted, but copper, aluminium, iron, stainless and the like can be preferably used. The conditions of heat-curing are the same as those of the aforementioned laminate.

Furthermore, the laminate of the present invention also includes a multi-layer laminate that is produced by laminating the both-sided metal clad laminate on which circuits are formed and prepregs with each other, and then laminating metal foils and metal plates on the outermost sides for hot pressing. The multi-layer laminate can be produced by using various methods which are used for a production process of a laminate for a multi-layer printed wiring board in general. Especially, a method is not particularly restricted.

### EXAMPLES

The present invention is described specifically below by way of Examples. However, the present invention is not restricted to these Examples.

### Examples 1 to 5 and Comparative Examples 1 to 2

Of compositions (weight parts) shown in Table 1, a mixture of (A), (B), (C) and other resigns was dissolved in a mixed solvent of methylethylketone and N-methyl-2-pyrrolidone (the mixing ratio of methylethylketone to N-methyl-2-pyrrolidone was 4 to 1) in a flask at 80° C. for 6 hours, thus obtaining a resin varnish. A metal hydroxide, curing accelerator, inorganic filler, and additive were added to the thus-obtained resin varnish. The resulting solution was uniformly stirred, which was impregnated in a glass fiber cloth of 108 g/m² (a thickness of about 100 μm) and dried at 150° C. for 5 minutes, thus obtaining a prepreg of about 200 g/m² (a thickness of about 100 μm). 5 sheets of the prepregs were folded one another. A copper foil of 18 μm was further arranged at the outermost layers thereof on the top and bottom, and molded under the heating conditions of 180° C. to 230° C. for 120 minutes under the pressure of 2 MPa, thus obtaining a copper clad laminate having a thickness of 0.5 to 0.7 mm. The test results of the thus-obtained laminate were shown in the Table in the same manner. The method of the test was indicated below. Also, to evaluate flame retardancy, a metal clad laminate having a thickness of 0.2 to 0.3 mm was used, which was produced in the same manner except that 2 sheets of the prepregs were folded one another.
(1) Flame Retardancy: It was measured according to the Flame Retardancy Test Method in UL94V Standard.
(2) Humidity Resistance: Using a pressure cooker, the weight after humidification for 24 hours was measured under the conditions of 121° C., 100% RH and 2.1 air pressure and the weight change rate was calculated on the basis of the weight before humidification, which was taken for the water absorption.
(3) Solder Heat Resistance: According to JIS C-6481, test pieces were water absorption-treated for 3 hours under the conditions of 121° C., 2.1 air pressure and 100% RH, and then floated at solder bath at an arbitrary temperature for 60 seconds. The highest temperature in which no blister occurred on the metal foil part was taken for the heat resistance temperature.

In Examples and Comparative Examples, the following raw materials were used.

(A) Compound Having at Least Two or More Maleimide Groups:

BMI-S (product name, the content of a nitrogen atom: approximately 8%, molecular weight: 358, manufactured by Mitsui Chemicals, Inc.)
BMI-MP (product name, the content of a nitrogen atom: approximately 10%, molecular weight: 268, manufactured by Mitsui Chemicals, Inc.)
   (B) Phenolic Resin:
Naphthol aralkyl resin, SN180 (product name, OH equivalent: 190, number of OH groups in a naphthalene ring: 1, manufactured by Nippon Steel Chemical Group)
Naphthol aralkyl resin, SN485 (product name, OH equivalent: 215, number of OH groups in a naphthalene ring: 1, manufactured by Nippon Steel Chemical Group)
   (C) Epoxy Resin:
Naphthalene type epoxy resin, Epicron HP4032 (product name, epoxy equivalent: 150, number of OH groups in a naphthalene ring: 2, manufactured by DaiNippon Ink and Chemicals, Inc.)
Naphthol aralkyl type epoxy resin, ESN175 (product name, epoxy equivalent: 270, number of OH groups in a naphthalene ring: 1, manufactured by Nippon Steel Chemical Group)
Dihydroxynaphthalene aralkyl type epoxy resin, ESN375 (product name, epoxy equivalent: 170, number of OH groups in a naphthalene ring: 2, manufactured by Nippon Steel Chemical Group)
Liquid bisphenol A type epoxy resin, Epikote 828EL (product name, epoxy equivalent: 190, no naphthalene rings included, manufactured by Japan Epoxy Resins Co., Ltd.)
   Other Resin Components:
Reactive diluent: allyl glycidyl ether (Epiole A (product name), manufactured by NOF Corp.)
Curing accelerator: 2-ethyl-4-methylimidazol (2E4MZ (product name), manufactured by Shikoku Corp.)
   Metal Hydroxide:
Aluminium hydroxide; HS-330 (product name, average particle diameter; 7 μm, amount of Na₂O; 0.04%, manufactured by Showa Denko K.K.)
Aluminium hydroxide: CL-303 (product name, center diameter; 2.5 μm, amount of Na2O; 0.21 %, manufactured by Sumitomo Chemicals Co., Ltd.)
   Inorganic filler:
Globule of silica; SO-C2 (product name, average particle diameter; 0.5 μm, manufactured by Tatsumori Co., Ltd.)

Additive (leveling agent): FTX218 (product name, manufactured by Neos Co., Ltd.)

TABLE 1

| Com- | | | | | | | |
|---|---|---|---|---|---|---|---|
| ponent | | | | | | Comparative | |
| Name and | Example | | | | | Example | |
| Test Items | 1 | 2 | 3 | 4 | 5 | 1 | 2 |
| (A) | | | | | | | |
| Maleimide | | | | | | | |
| BMI-S | 55 | 55 | | 50 | 45 | 50 | 50 |
| BMI-MP | | | 50 | | | | |
| (B) | | | | | | | |
| Phenolic | | | | | | | |
| resin | | | | | | | |
| SN485 | 16 | 16 | 18 | | 11 | 16 | 16 |
| SN180 | | | | 12 | | | |
| (C) Epoxy | | | | | | | |
| resin | | | | | | | |
| HP4032 | | | 27 | | | 13 | |
| ESN175 | 29 | 27 | | | 37 | | |
| ESN375 | | | | 31 | | | |
| Epikote | | 2 | | 2 | 2 | 16 | 29 |
| 828EL | | | | | | | |
| Reactive | | | 5 | 5 | 5 | 5 | 5 |
| diluent | | | | | | | |
| Curing | | 0.05 | 0.05 | | 0.05 | 0.05 | 0.05 |
| accelerator | | | | | | | |
| Metal | | | | | | | |
| hydroxide | | | | | | | |
| HS-330 | | 25 | | | 35 | 80 | 133 |
| CL303 | | | 50 | | 13 | | |
| Inorganic | | 25 | | | 20 | | |
| filler | | | | | | | |
| Additive | | 0.005 | | | 0.005 | | |
| Mnap | 23% | 22% | 22% | 20% | 24% | 15% | 10% |
| (total) | | | | | | | |
| Mnap | 78% | 77% | 72% | 70% | 69% | 65% | 60% |
| (total) + | | | | | | | |
| Xm | | | | | | | |
| Nitrogen | 4.4 | 4.4 | 5 | 4 | 3.6 | 4 | 4 |
| % | | | | | | | |
| Flame | V-1 | V-0 | V-0 | V-1 | V-0 | V-2out | V-0 |
| retardancy | | | | | | | |
| (0.2 mm) | | | | | | | |
| Hygro- | 280 | 280 | 280 | 280 | 280 | 260 | <260 |
| scopic | | | | | | | |
| solder heat | | | | | | | |
| resistance | | | | | | | |
| Water | 1.0% | 1.0% | 1.0% | 1.1% | 0.9% | 1.5% | 2.4% |
| absorption | | | | | | | |

In comparison with examples, comparative example 1 shows that Mₙₐₚ(total) was less than 20% so that flame retardancy was not sufficient. Also, comparative example 2 shows that the content added of hydroxide was high so that flame retardancy was sufficient, but the total weight of the naphthalene ring in the resin composition did not reach not less than 20 weight % and Mₙₐₚ(total)+Xₘ was less than 65% so that solder heat resistance was deteriorated after humidification and the water absorption was also high as compared to the example.

Industrial Applicability

The resin composition of the present invention can obtain flame retardancy without containing a halogen compound and a phosphorous compound. So, when it is used as printed wiring board materials used for electronic parts and the like, a load to the environment is relatively low (the composition does not contain any compounds which might have a bad effect on the environment). Also, the resin composition of the present invention is superior in humidity resistance, humidity resistance and heat resistance, which can be used at a process using Pb-free solder. As a result, a load to the environment becomes low as the whole electronic parts after solder mounting.

1. A resin composition comprising:
(A) a compound having at least two or more maleimide groups;
(B) a phenolic resin; and
(C) an epoxy resin;
wherein at least one of said (B) or (C) has a naphthalene ring;
the total weight of the naphthalene ring when calculated using the OH equivalent and epoxy equivalent of (B) and (C) respectively is not less than 20 weight % to the total weight of the (A), (B) and (C) components; and
the total sum of the content ratio of the (A) component and that of the naphthalene ring is not less than 65 weight % to the total weight of the (A), (B) and (C) components.

2. The resin composition according to claim 1, wherein the content of the (A) compound having at least two or more maleimide groups is not less than 3.5 weight % to the total weight of the (A), (B) and (C) components as the content of a nitrogen atom contained in a maleimide ring.

3. The resin composition according to claim 1, further comprising a metal hydroxide.

4. A prepreg obtained by impregnating a substrate with the resin composition as described in claim 1.

5. A laminate wherein a sheet or a plurality of sheets laminated of the prepregs as described in claim 4 are characterized in being heat-cured.

6. A laminate comprising the resin obtained from the resin composition as described in claim 1 as an insulating layer.
